(19) United States
(12) Patent Application Publication
(10) Pub. No.: US 2010/0309395 A1
(43) Pub. Date: Dec. 9, 2010

(54) FRAME UNIT FOR VIDEO DISPLAY DEVICES, AND VIDEO DISPLAY DEVICE

(75) Inventors: Hideo MURATA, Tokyo (JP); Shigeyuki OGAWA, Tokyo (JP)

Correspondence Address: ROBERT J. DEPKE;LEWIS T. STEADMAN, ROCKEY, DEPKE & LYONS, LLC, SUITE 5450 SEARS TOWER, CHICAGO, IL, 60606-6306, US

(73) Assignee: SONY CORPORATION, Tokyo (JP)

(21) Appl. No.: 12/772,186

(22) Filed: May 1, 2010

(30) Foreign Application Priority Data
Jun. 4, 2009 (JP) 2009-134787

(51) Int. Cl. H04N 5/64

(52) U.S. Cl. 348/842; 348/836; 348/E05.128

(57) ABSTRACT

A frame unit for a video display device includes a frame and a polarizer. The frame has a frame body and a plurality of mutually facing legs. The frame body is disposed around a light emitting unit and the legs extend from the frame body and are fitted along side surfaces of the light emitting unit. The polarizer extends between the mutually facing legs of the frame.

### CROSS REFERENCE TO RELATED APPLICATIONS

The present application claims priority to Japanese Patent Application JP 2009-134787 filed in the Japan Patent Office on Jun. 4, 2009, the entire content of which is hereby incorporated by reference.

### BACKGROUND OF THE INVENTION

1. Field of the Invention

The present invention relates to a frame unit for video display devices and to a video display device. More specifically, the present invention relates to a frame unit on which a polarizing plate for a video display device can be mounted if necessary and to a video display device.

2. Description of the Related Art

In recent years, large-sized video display devices employing light emitting diodes (LEDs), plasma display panels (PDP), fluorescent tubes, fluorescent lamps, etc. are in widespread use. In addition, there are devised techniques for emitting light from odd and even lines in vibration directions orthogonal to each other to enable stereoscopic video images to be visualized through polarizing glasses (see Japanese Unexamined Patent Application Publication No. 2003-029207).

### SUMMARY OF THE INVENTION

To implement such a stereoscopic video display device, it is necessary to provide polarizing plates having different polarization directions on the front surfaces of the light emitting units of a unitized video display unit so that the polarization direction can be changed for each line. A plurality of linear polarizing plates or an integrated polarizing plate is bonded to the forefront surface of the video display device. Problems with these polarizing plates are that it takes a considerable time and effort to bond and that the surfaces of the polarizing plates bonded to the forefront surfaces of the video display device reflect the outside light and cause trouble viewing video images.

It is desirable to facilitate the mounting of polarizers on a video display unit and to improve display characteristics.

According to an embodiment of the present invention, a frame unit for a video display device includes a frame and a polarizer. The frame has a frame body and mutually facing legs. The frame body is disposed around light emitting units. The legs extend from the frame body so as to fit along side surfaces of the light emitting units. The polarizer extends between the mutually facing legs of the frame.

According to this embodiment, the polarizer is disposed between the legs of the frame, which are fitted around the light emitting units, so the polarizer can be mounted at the right position with respect to the light emitting units simply by fitting the frame around the light emitting units.

In this embodiment, the frame is made of a flexible material and detachably fitted around the light emitting units, so the frame combined with the polarizer can be mounted and demounted easily as desired.

At least the front surface of the frame body is colored so as to suppress the reflection of light. According to this embodiment, the polarizer is disposed on the back of the frame from which the legs extend. When the frame is fitted around the light emitting units, the polarizer is positioned between the light emitting units and the frame body and the front surface of the frame body surrounding the light emitting units faces the viewer viewing the light emitting side of the light emitting units. If the front surface of frame body is colored in a color that suppresses the reflection of light, the frame body can prevent the diffuse reflection of outside light and thus serve as black stripes.

According to another embodiment of the present invention, a video display device includes a video display unit, a frame, and a plurality of polarizers. The video display unit has a plurality of light emitting units arranged in rows and columns. The frame has a frame body and a plurality of mutually facing legs, the frame body being disposed around the light emitting units of the video display unit, the legs extending from the frame body and fitted into gaps between the light emitting units. The polarizers are disposed so as to extend between the mutually facing legs of the frame.

In this embodiment, since the polarizers are disposed between the mutually facing legs of the frame to be fitted around the light emitting units, the polarizers corresponding to the light emitting units can be mounted on the video display unit simply by fitting the frame around the light emitting units. Alternatively, polarizing plates may be built in advance into the surfaces of the LED chips or LED packages used as the light emitting units of the stereoscopic video image display unit.

According to the embodiments of the present invention, the polarizers can be mounted on the video display unit in an easy and precise manner as desired.

### BRIEF DESCRIPTION OF THE DRAWINGS

FIG. 1 is a perspective view illustrating the basic structure of a frame unit for video display devices according to an embodiment of the present invention;

FIG. 2 is an exploded perspective view of the frame unit for video display devices according to this embodiment;

FIG. 3A is a sectional view illustrating the mounted and unmounted states of the frame unit for video display devices according to this embodiment;

FIG. 3B is a sectional view illustrating the mounted and unmounted states of another frame unit for video display devices according to another embodiment;

FIGS. 4A and 4B are perspective views illustrating an exemplary linear frame unit for video display devices;

FIG. 5 is a perspective view illustrating a matrix (rows and columns)-type frame unit for video display devices;

FIG. 6 is an exploded perspective view of a matrix (rows and columns)-type frame unit for video display devices;

FIGS. 7A and 7B are perspective views illustrating a video display device according to an embodiment of the present invention;

FIG. 8 illustrates a video display device according to this embodiment that is being used for viewing a stereoscopic video image; and

FIGS. 9A and 9B illustrate exemplary structures of light emitting units.

### DESCRIPTION OF THE PREFERRED EMBODIMENTS

A best mode (referred to below as an embodiment) for carrying out the present invention will now be described in the following order:

1. Frame units for video display devices (exemplary basic structure of frame unit, exploded perspective view, mounted and unmounted states, exemplary linear structure, exemplary matrix structure)

2. Video display device (exemplary structure of a frame unit, viewing of video images)

3. Exemplary structures of light emitting units (rectangular package, round package)<

1. Frame units for video display devices>

### [Basic Structure of Frame Unit]

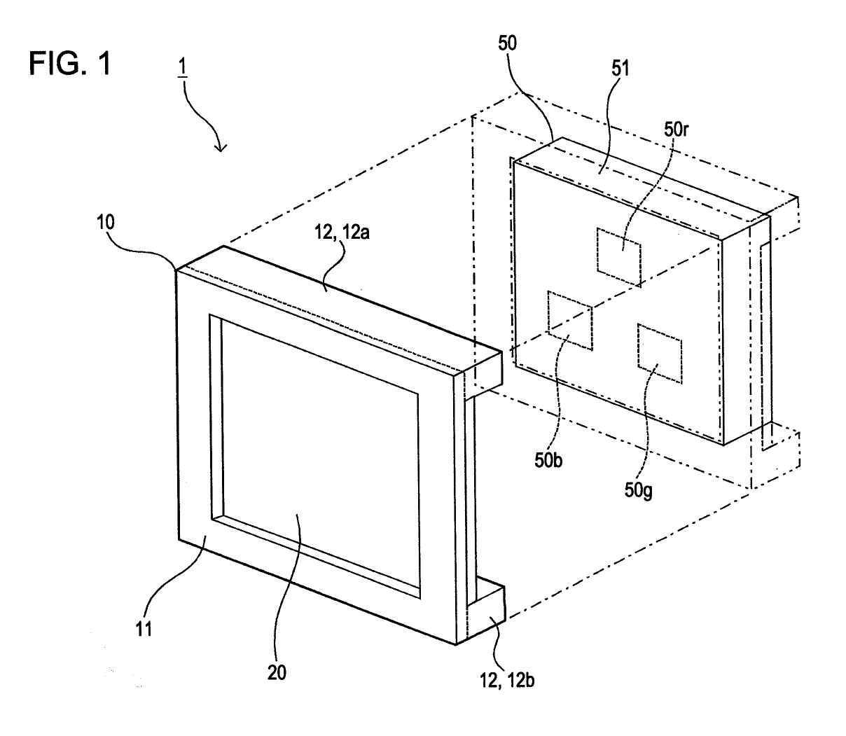

FIG. 1 is a perspective view illustrating the basic structure of a frame unit according to an embodiment of the present invention. The frame unit 1 with the basic structure accommodates a single light emitting unit 50. The frame unit 1 includes a frame 10 and a polarizer 20.

The frame 10 has a frame body 11 and mutually facing legs 12. The frame body 11 is a frame-shaped member corresponding to the outer shape of the light emitting unit 50, so that it can be disposed around the light emitting unit 50. The legs 12 are members extending from the frame body 11 and are fitted along side surfaces of the light emitting unit 50. In FIG. 1, the legs 12 protrude backward from the horizontal edges of the frame body 11.

Alternatively, the legs 12 may be disposed along the vertical edges of the frame body 11 in FIG. 1. Although the frame body 11 and the legs 12 are separated by dashed lines in FIG. 1 for convenience of description, the frame body 11 and the legs 12 may actually be molded as a single piece. The legs 12 may be provided partially along the horizontal edges of the frame body 11, instead of being provided entirely along the horizontal edges as shown in FIG. 1.

The polarizer 20 is a filter for controlling the polarization direction of the light emitted by the light emitting unit 50, for S-polarization (polarization direction perpendicular to the light incident surface), P-polarization (polarization direction parallel to the light incident surface), circular polarization (clockwise or counterclockwise), elliptical polarization, etc.

The polarizer 20 is disposed so as to extend between the mutually facing legs 12 of the frame 10. In FIG. 1, the polarizer 20 extends between the upper leg 12a and lower leg 12b provided on the mutually facing horizontal edges of the frame 10, so the polarizer 20 entirely covers the opening defined by the frame body 11 of the frame 10.

The frame unit 1 thus structured is detachably fitted around the light emitting unit 50. The light emitting unit 50 contains, for example, a light emitting element 50r emitting red light, a light emitting element 50g emitting green light, and a light emitting element 50b emitting blue light and is sealed in a package 51. The package 51 is rectangular in shape, for example, and the frame body 11 and legs 12 are sized to fit to the outer dimensions of the package 51.

Once the frame unit 1 is fitted around the light emitting unit 50, the package 51 of the light emitting unit 50 is fitted between the mutually facing legs 12, i.e., the upper and lower legs 12a, 12b in FIG. 1. Since the inner dimension between the upper and lower legs 12a, 12b is substantially the same as the height of the package 51 of the light emitting unit 50, the frame unit 1 can be fitted with no misalignment.

The frame 10 may be made of a flexible material such as a rubber-based (silicone rubber, etc.) material, for example, to facilitate the mounting and demounting of the frame unit 1 from the light emitting unit 50.

If the frame 10 is made of a flexible material, the inner dimension between the upper and lower legs 12a, 12b may be slightly smaller than the height of the package 51 of the light emitting unit 50, so that the frame 10 can be securely fixed to the package 51 by the force of reaction of the warped legs 12a, 12b once the frame 10 is fitted around the package 51.

At least the front surface of the frame body 11 of the frame 10 is colored in black, dark gray, or another color that suppresses the reflection of light, so that the frame body 11 can prevent the diffuse reflection of outside light (other than the light from the light emitting unit 50) and thus serve as the black stripes of the video display device. Alternatively, the front surface of the frame body 11 may suppress the reflection of light by the color of the material itself or by the surface treatment (surface asperities, for example). Although not shown, an overhang (canopy) may be provided on the upper front of the frame body 11 as a sunshade in case the video display device is installed outdoors.

### [Exploded Perspective View]

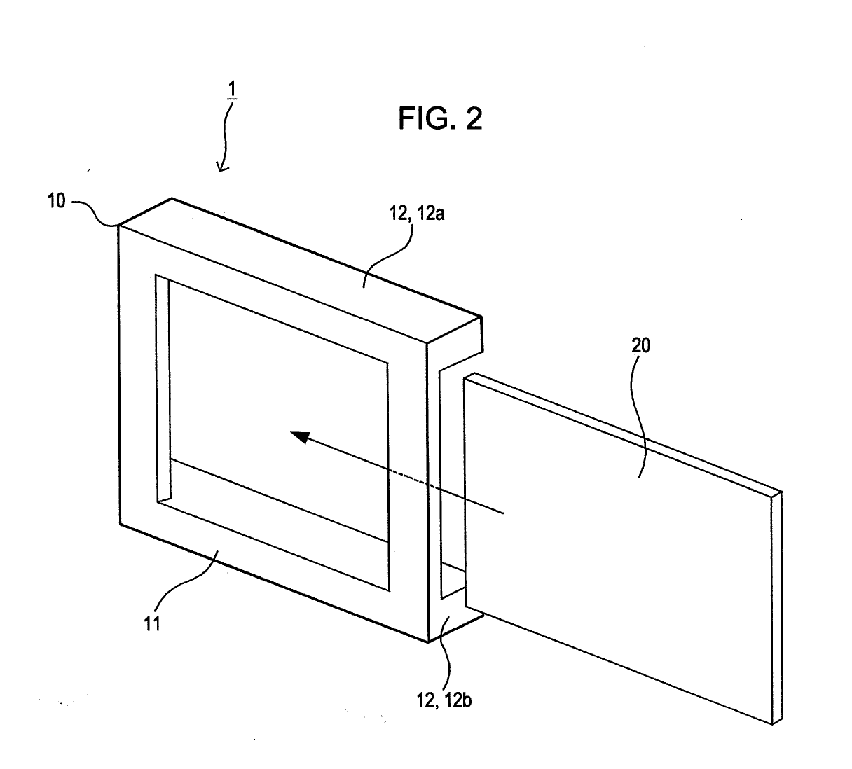

FIG. 2 is an exploded perspective view of the frame unit according to this embodiment. The frame unit 1 includes a frame 10 and a polarizer 20 which is fitted between the mutually facing legs 12 of the frame 10. The polarizer 20 may be fitted between the upper and lower legs 12a, 12b or bonded to the back of the frame body 11. If the polarizer 20 is fitted between the upper and lower legs 12a, 12b, the polarizer 20 can be inserted or extracted as desired.

In this embodiment, the polarizer 20 is disposed on the back of the frame body 11 or at a position in the frame body 11, so that, once the frame 10 is mounted on the light emitting unit, the front surface of the frame body 11 surrounding the light emitting unit on the forefront of the video display unit faces the viewer and serves as the black stripes of the video display device. Since the polarizer 20 is surrounded by the frame body 11, the polarizer 20 is improved in directivity and protected from deformation and scratches. Furthermore, the polarizer 20 can be protected from deterioration, because the frame body 11 reduces the direct incidence of outside light.

### [Mounted and Unmounted States]

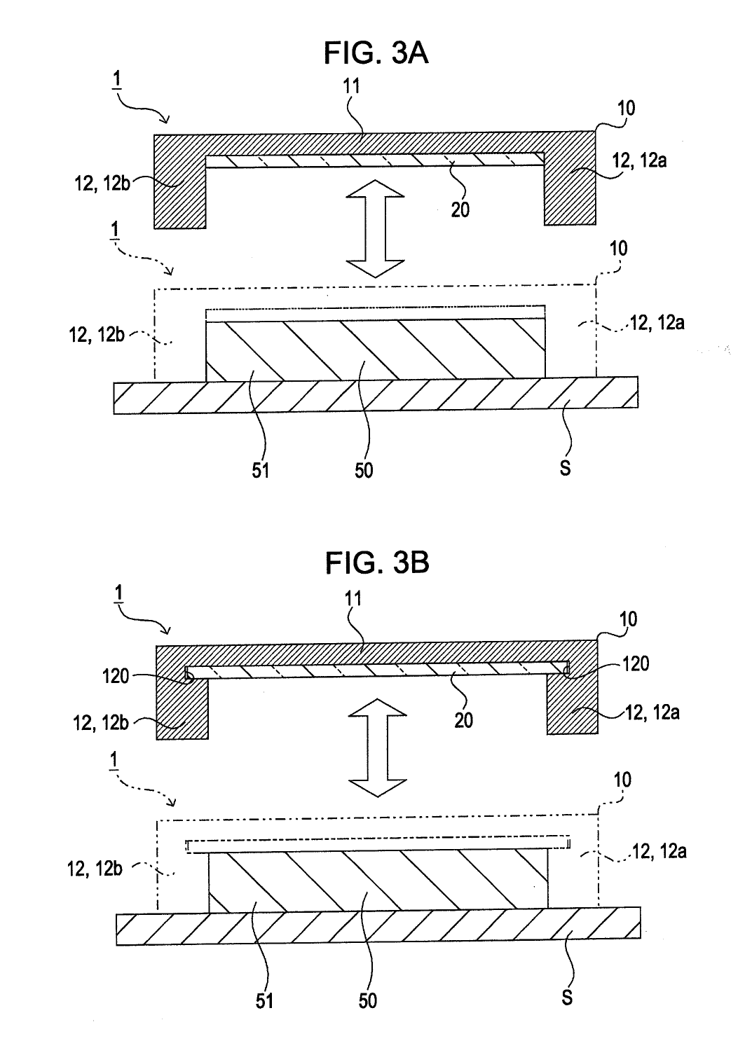

FIGS. 3A and 3B are sectional views illustrating the mounted and unmounted states of the frame unit according to this embodiment. As shown in FIG. 3A, the frame unit 1 has the polarizer 20 fitted between the legs 12 of the frame 10. The light emitting unit 50 is mounted on a substrate S and has electrodes (not shown) electrically connected, by soldering for example, to the wiring pattern on the substrate S. The frame unit 1 is fitted over the package 51 of the light emitting unit 50.

Since the inner dimension between the legs 12 (12a, 12b) is substantially the same as the height of the package 51 of the light emitting unit 50, the package 51 of the light emitting unit 50 is precisely fitted between the legs 12 (12a, 12b) once the frame unit 1 is fitted over the light emitting unit 50. Since the polarizer 20 is disposed between the legs 12 (12a, 12b) on the back of the frame body 11, the polarizer 20 faces the light emitting surface of the light emitting unit 50 once the frame unit 1 is fitted over the light emitting unit 50.

FIG. 3B is a sectional view showing recesses provided in the legs. In this embodiment, recesses 120 are provided in the legs 12 (12a, 12b) in the frame 10 of the frame unit 1 and a polarizer 20 is inserted into the recesses 120. The recesses 120 have mutually facing openings in the portions of the legs 12 (12a, 12b) adjacent to the frame body 11, so that the polarizer 20 wider than the inner dimension between the legs 12 (12a, 12b) can be inserted in the recesses 120. These recesses 120 receive the polarizer 20 when it is fitted between the legs 12 (12a, 12b).

In FIGS. 3A and 3B, if the legs 12 have a length equivalent to the thickness of the light emitting unit 50 plus the thickness of the polarizer 20, the polarizer 20 is brought into close contact with the light emitting unit 50 and the bottoms of the legs 12 abut the substrate S once the frame unit 1 is fitted over the light emitting unit 50. In this arrangement, if adhesive is applied to the bottoms of the legs 12, the frame 10 is securely fixed. If the frame 10 is flexible, the bottoms of the legs 12 fixed by adhesive to the substrate S can be detached from the substrate S simply by warping the frame 10 starting with one end thereof.

Alternatively, surface asperities may be provided on the inner wall surfaces of the legs 12 (12a, 12b), which are brought into contact with the side surfaces of the package 51 of the light emitting unit 50 once the frame unit 1 is fitted over the light emitting unit 50. These surface asperities increase the force of friction between the inner wall surfaces of the legs 12 (12a, 12b) and the side surfaces of the package 51 of the light emitting unit 50 and thereby enhance the holding power of the legs 12 (12a, 12b) once the frame unit 1 is fitted over the light emitting unit 50.

### [Linear Structure]

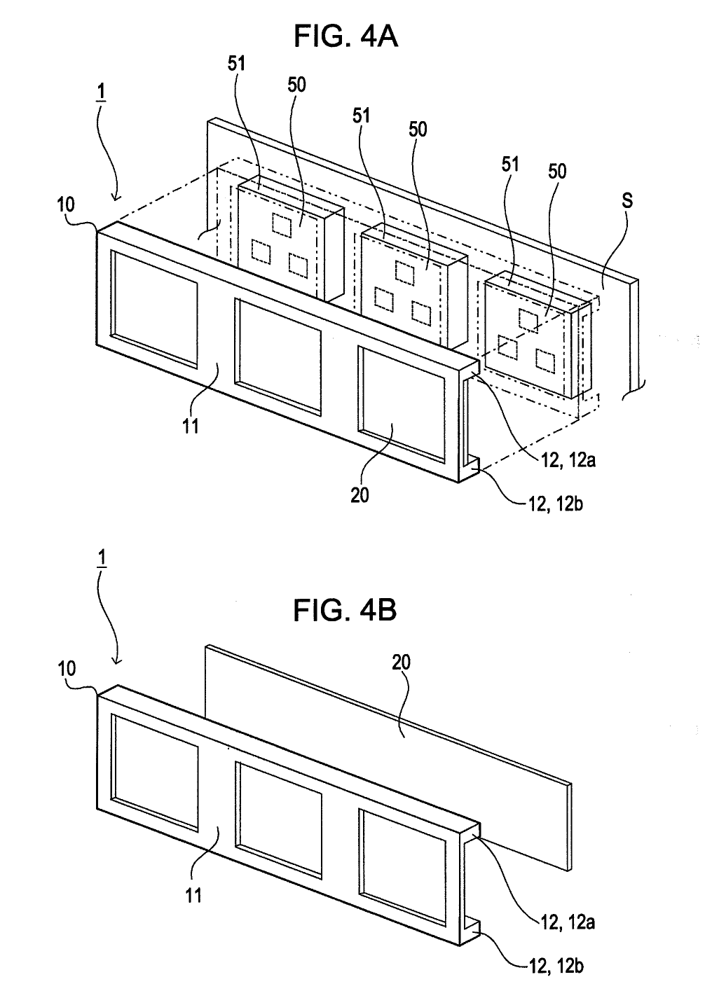

FIG. 4A is a perspective view illustrating the overall structure of a linear frame unit; FIG. 4B is an exploded view of this frame unit. The frame unit 1 is suitable for a plurality of light emitting units 50 arranged in a row or column. The light emitting units 50 are arranged at predetermined intervals on the substrate S. In FIG. 4A, the light emitting units 50 are arranged in a row.

The frame 10 of the frame unit 1 is disposed along this row of light emitting units 50. The frame body 11 of the frame 10 is molded into a shape of a frame including portions running between and around the light emitting units 50. The legs 12 are mutually facing members extending from the frame body 11 so as to be fitted along side surfaces of the light emitting units 50. In FIGS. 4A and 4B, the legs 12 extend backward from the horizontal edges of the frame body 11.

Alternatively, the legs 12 may be disposed along the vertical edges of the frame body 11 in FIGS. 4A and 4B. Although the frame body 11 and the legs 12 are separated by dashed lines in FIGS. 4A and 4B for convenience of description, the frame body 11 and the legs 12 may actually be molded as a single piece. The legs 12 may be provided partially along the horizontal edges of the frame body 11, instead of being provided entirely along the horizontal edges as shown in FIGS. 4A and 4B.

The polarizer 20 is a filter for controlling the polarization direction of the light emitted by the light emitting units 50, for S-polarization (polarization direction perpendicular to the light incident surface), P-polarization (polarization direction parallel to the light incident surface), circular polarization (clockwise or counterclockwise), elliptical polarization, etc.

The polarizer 20 is disposed so as to extend between the mutually facing legs 12 of the frame 10. In FIG. 4A, the polarizer 20 extends between the upper leg 12a and lower leg 12b provided on the mutually facing horizontal edges of the frame 10, so the polarizer 20 entirely covers the openings defined by the frame body 11 of the frame 10.

The frame unit 1 thus structured is detachably fitted around the plurality of light emitting units 50. When the frame unit 1 is fitted over the light emitting units 50, the packages 51 of the light emitting units 50 are fitted between the mutually facing legs 12, i.e., the upper and lower legs 12a, 12b in FIG. 4A. Since the inner dimension between the upper and lower legs 12a, 12b is substantially the same as the height of the package 51 of the light emitting unit 50, the frame unit 1 can be fitted with no misalignment.

The frame 10 may be made of a flexible material such as a rubber-based (silicone rubber, etc.) material, for example, to facilitate the mounting and demounting of the frame unit 1 from the light emitting unit 50.

If the frame 10 is made of a flexible material, the inner dimension between the upper and lower legs 12a, 12b may be slightly smaller than the height of the package 51 of the light emitting unit 50, so that the frame 10 can be securely fixed to the packages 51 by the force of reaction of the warped legs 12a, 12b once the frame 10 is fitted around the packages 51.

At least the front surface of the frame body 11 of the frame 10 is colored in black, dark gray, or another color that suppresses the reflection of light, so that the frame body 11 can prevent the diffuse reflection of outside light (other than the light from the light emitting unit 50) and thus serve as the black stripes of the video display device.

As shown in FIG. 4B, the frame unit 1 includes a frame 10 and a polarizer 20 which is fitted between the mutually facing legs 12 of the frame 10. The polarizer 20 may be fitted between the upper and lower legs 12a, 12b or bonded to the back of the frame body 11. If the polarizer 20 is fitted between the upper and lower legs 12a, 12b, the polarizer 20 can be inserted or extracted as desired.

If the frame unit 1 is fitted over a plurality of light emitting units 50 arranged in a row, a long polarizer 20 extending along this row is inserted between the upper and lower legs 12a, 12b as shown in FIG. 4B. If recesses 120 are provided in the upper and lower legs 12a, 12b as shown in FIG. 3B, the long polarizer 20 can be inserted easily and reliably, guided by the recesses 120.

### [Matrix Structure]

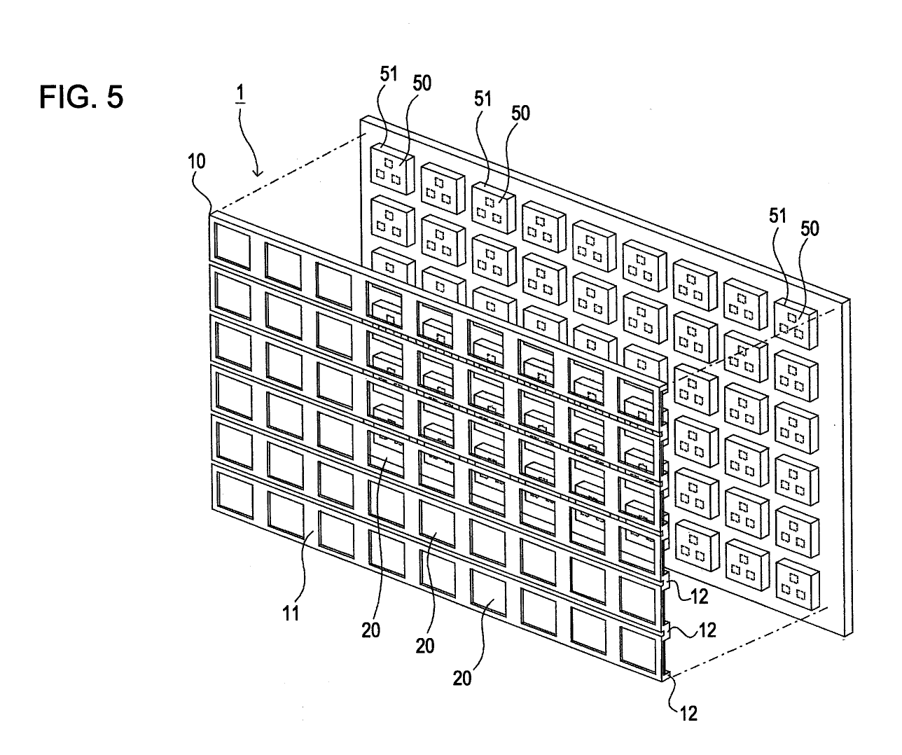

FIG. 5 is a perspective view illustrating a frame unit implemented as a matrix (rows and columns). This frame unit 1 is suitable for a plurality of light emitting units 50 arranged in a matrix. The light emitting units 50 are arranged in rows and columns at predetermined intervals on the substrate .

The frame 10 of the frame unit 1 is disposed along the rows and columns of light emitting units 50. The frame body 11 of the frame 10 is molded into a shape of a frame including portions running between and around the light emitting units 50. Legs 12 are mutually facing members extending from the frame body 11 so as to be fitted along side surfaces of the light emitting units 50. In FIG. 5, the legs 12 extend backward from the horizontal edges of the frame body 11.

Alternatively, the legs 12 may be disposed along the vertical edges of the frame body 11 in FIG. 5. Although the frame body 11 and the legs 12 are described as discrete parts for convenience of description, the frame body 11 and the legs 12 may actually be molded as a single piece. The legs 12 may be provided partially along the horizontal edges of the frame body 11, instead of being provided entirely along the horizontal edges as shown in FIG. 5.

The polarizer 20 is a filter for controlling the polarization direction of the light emitted by the light emitting units 50, for S-polarization (polarization direction perpendicular to the light incident surface), P-polarization (polarization direction parallel to the light incident surface), circular polarization (clockwise or counterclockwise), elliptical polarization, etc.

The polarizers 20 are disposed so as to extend between the mutually facing legs 12 of the frame 10. In FIG. 5, the polarizers 20 extend between the upper and lower legs 12 provided on the mutually facing horizontal edges of the frame 10, so the polarizers 20 entirely covers the openings defined by the frame body 11 of the frame 10.

The frame unit 1 thus structured is detachably fitted around the plurality of light emitting units 50. When the frame unit 1 is fitted over the light emitting units 50, the packages 51 of the light emitting units 50 are fitted between the mutually facing legs 12. Since the inner dimension between the mutually facing upper and lower legs 12 is substantially the same as the height of the package 51 of the light emitting unit 50, the frame unit 1 can be fitted with no misalignment.

The frame 10 may be made of a flexible material such as a rubber-based (silicone rubber, etc.) material, for example, to facilitate the mounting and demounting of the frame unit 1 from the light emitting unit 50.

If the frame 10 is made of a flexible material, the inner dimension between the upper and lower legs 12a, 12b may be slightly smaller than the height of the package 51 of the light emitting unit 50, so that the frame 10 can be securely fixed to the packages 51 by the force of reaction of the warped legs 12a, 12b once the frame 10 is fitted around the packages 51.

At least the front surface of the frame body 11 of the frame 10 is colored in black, dark gray, or another color that suppresses the reflection of light, so that the frame body 11 can prevent the diffuse reflection of outside light (other than the light from the light emitting unit 50) and thereby serve as the black stripes of the video display device.

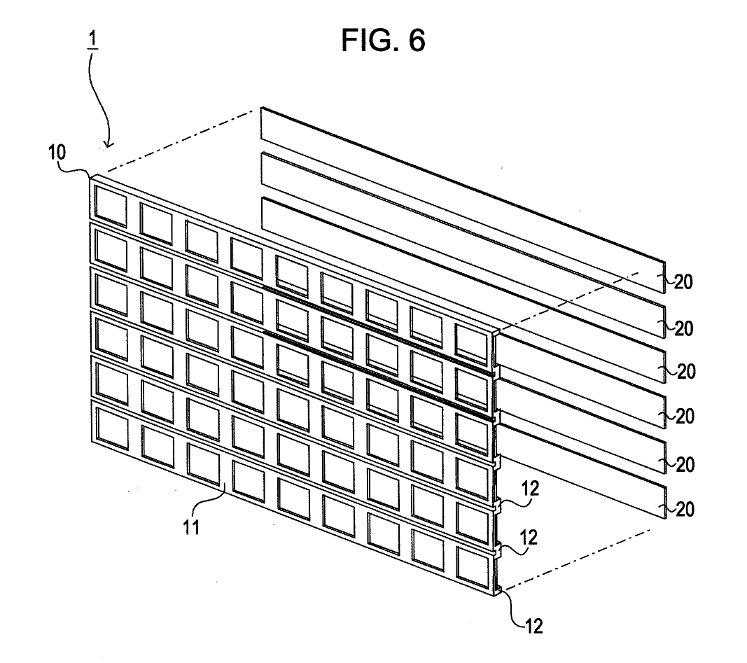

FIG. 6 is an exploded perspective view of the frame unit. As shown in FIG. 6, the frame unit 1 includes a frame and polarizers 20 which are fitted between the mutually facing legs 12 of the frame 10. The polarizers 20 may be fitted between the mutually facing upper and lower legs 12 or bonded to the back of the frame body 11. If the polarizers 20 are fitted between the mutually facing upper and lower legs 12, the polarizers 20 can be inserted or extracted as desired.

If the frame unit 1 is fitted over a plurality of light emitting units 50 arranged in a matrix, long polarizers 20 extending along the rows of light emitting units 50 are inserted between the mutually facing upper and lower legs 12 as shown in FIG. 6. If recesses 120 are provided in the upper and lower legs 12 as shown in FIG. 3B, the long polarizers 20 can be inserted easily and reliably, guided by the recesses 120.

If the long polarizers 20 are mounted for individual rows, the polarization direction of the polarizers 20 can be set for each row. For example, the polarizers 20 may be mounted so that the polarization direction is changed alternately in every other row.

<2. Video display device>

### [Frame Structure]

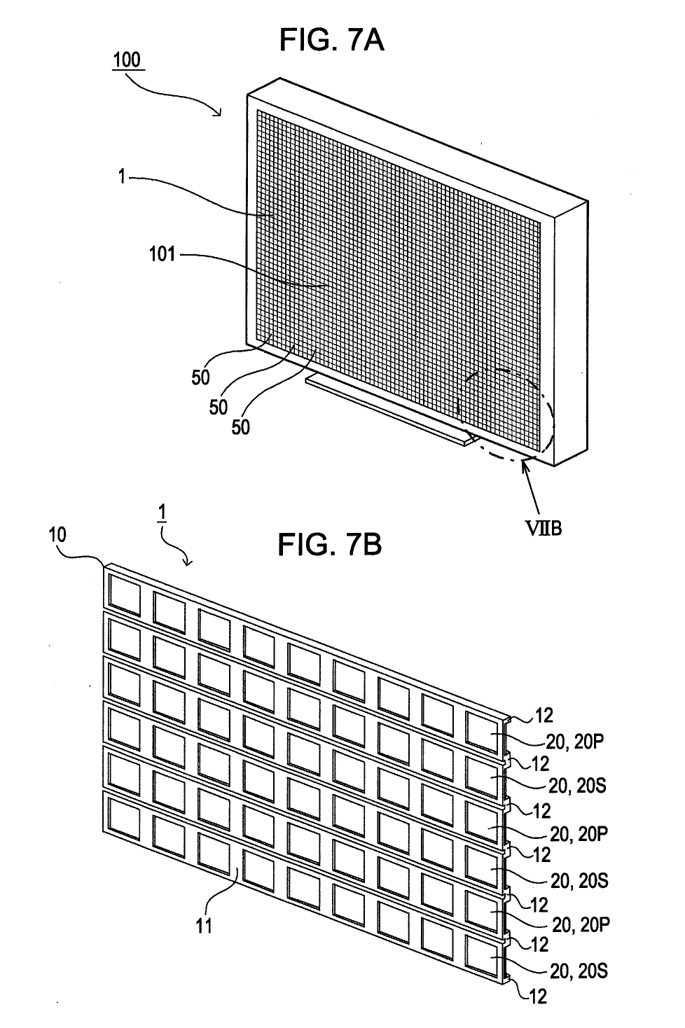

FIGS. 7A and 7B are perspective views illustrating a video display device according to another embodiment of the present invention. The video display device 100 has a video display unit 101 having a plurality of light emitting units 50 arranged in a matrix and the frame unit 1 according to the embodiment described earlier mounted thereon.

As shown in FIG. 7B, there is applied the frame unit 1 implemented as the matrix shown in FIGS. 5 and 6. The frame unit 1 is preferably implemented as a matrix for efficiency of mounting, although the frame unit 1 in the basic structure shown in FIG. 1 or in the linear structure shown in FIGS. 4A and 4B may be employed. If the matrix-type frame unit 1 is employed, the entire surface of the video display unit 101 may be covered with a single frame unit 1 or a plurality of frame units 1 that are sized to cover predetermined partitions of the entire surface of the video display unit 101.

The frame 10 of the frame unit 1 is disposed along the rows and columns of light emitting units 50. The frame body 11 of the frame 10 is molded into a shape of a frame including portions running between and around the light emitting units 50. The legs 12 are mutually facing members extending from the frame body 11 so as to be fitted along side surfaces of the light emitting units 50.

The polarizer 20 is a filter for controlling the polarization direction of the light emitted by the light emitting unit 50, for S-polarization (polarization direction perpendicular to the light incident surface), P-polarization (polarization direction parallel to the light incident surface), circular polarization (clockwise or counterclockwise), elliptical polarization, etc.

The frame unit 1 thus structured is detachably fitted around the plurality of light emitting units 50 forming part of the video display unit 101. When the frame unit 1 is fitted over the light emitting units 50, the packages 51 of the light emitting units 50 are fitted between the mutually facing legs 12. Since the inner dimension between the mutually facing upper and lower legs 12 is substantially the same as the height of the package 51 of the light emitting unit 50, the frame unit 1 can be fitted with no misalignment.

The frame 10 may be made of a flexible material, such as a rubber-based (silicone rubber, etc.) material, for example, to facilitate the mounting and demounting of the frame unit 1 from the video display unit 101.

At least the front surface of the frame body 11 of the frame 10 is colored in black, dark gray, or another color that suppresses the reflection of light, so that the frame body 11 can prevent the diffuse reflection of outside light (other than the light from the light emitting unit 50) and thus serve as the black stripes provided in the gaps between the light emitting units 50 of the video display unit 101.

In this embodiment, the frame unit 1 accommodates long polarizers 20 associated with the individual rows of the video display unit 101. The long polarizers 20 are inserted between the mutually facing upper and lower legs 12a, 12b. If recesses 120 are provided in the upper and lower legs 12 as shown in FIG. 3B, the long polarizers 20 can be inserted easily and reliably, guided by the recesses 120.

If the video display device 100 is used to visualize stereoscopic video images, the polarizers 20 are mounted so that the polarizing direction is changed alternately in every other row. For example, polarizers 20P for converting the light emitted from the light emitting units 50 into P-polarized light and polarizers 20S for converting the light emitted from the light emitting units 50 into S-polarized light are arranged alternately in every other row.

Alternatively, polarizers of other polarizing directions may be employed, instead of the polarizers 20P, 20S for P-polarization and S-polarization arranged alternately in every other row in this example.

### [Viewing of Video Images]

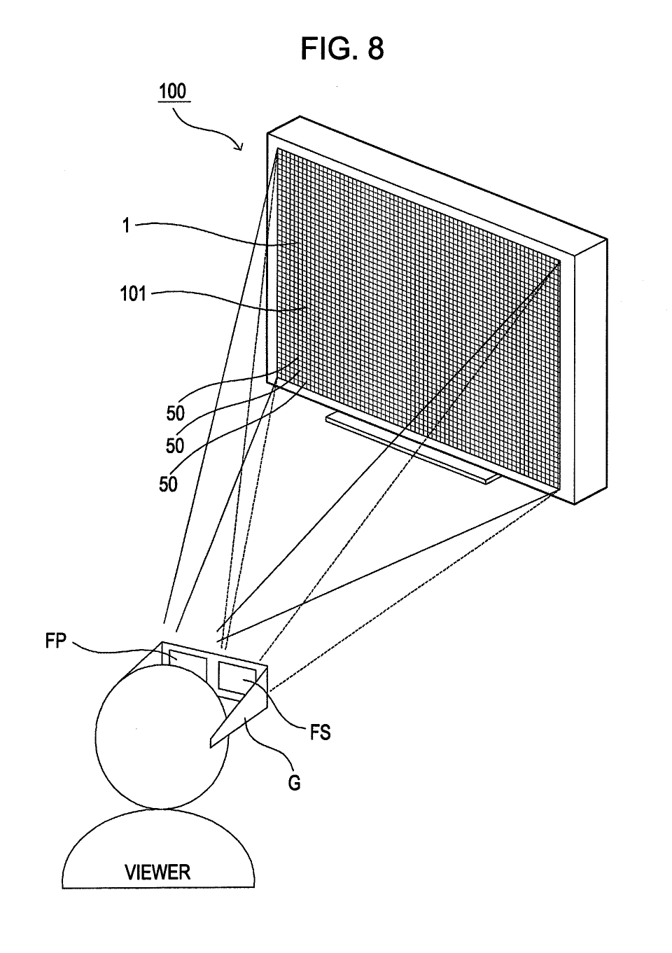

FIG. 8 illustrates a video display device according to this embodiment being used for viewing stereoscopic video images. A video display device 100 has a video display unit 101 having a plurality of light emitting units 50 arranged in a matrix and the frame unit 1 according to the embodiment described earlier mounted thereon. Although not shown, polarizers 20P for P-polarization and polarizers 20S for S-polarization are arranged alternately in every other row in the frame unit 1.

To visualize a stereoscopic video image, the video display device 100 changes the displayed video images alternately in odd and even rows.

In the frame unit 1 according to the embodiment described earlier, the polarizers in the odd rows convert the light emitted from the odd lines into S-polarized (or P-polarized) light and the polarizers in the even rows convert the light emitted from the even lines into P-polarized (or S-polarized) light.

The viewer views the video images with the right and left eyes through eyeglasses G that transmit the light polarized in different directions. For example, the eyeglasses G have a filter FP that transmits the P-polarized light toward the left eye and another filter FS that transmits the S-polarized light toward the right eye. In this manner, the right and left eyes of the viewer separately view the light polarized in different directions.

Suppose that the polarizers 20 in the frame unit 1 convert the image in the odd rows in the video display device 100 into P-polarized light and the image in the even rows into S-polarized light. It is assumed here that the eyeglasses G have a filter FP that transmits the P-polarized light toward the left eye and another filter FS that transmits the S-polarized light toward the right eye.

In this case, the image in the odd rows of the video display device 100 is converted into P-polarized light and reaches the left eye of the viewer wearing the eyeglasses G through the filter FP that transmits the P-polarized light. Since the filter FS for the right eye does not transmit the P-polarized light, the image in the odd rows does not reach the right eye of the viewer and is viewed only with the left eye.

On the other hand, the image in the even rows of the video display device 100 is converted into S-polarized light and reaches the right eye of the viewer wearing the eyeglasses G through the filter FS that transmits the S-polarized light. Since the filter FP for the left eye does not transmit the S-polarized light, the image in the even rows does not reach the left eye and is viewed only with the right eye.

In this manner, the viewer wearing the eyeglasses G views with the left eye the image displayed in the odd rows in the video display device 100 and with the right eye the image displayed in the even rows. The video display device 100 converts a video image into an image displayed in the odd rows and another image displayed in the even rows so that a stereoscopic video image can be visualized. The viewer recognizes the stereoscopic video image by viewing the converted images with the right and left eyes.

Since the frame unit 1 is detachably mounted on the video display device 100 according to this embodiment, the frame unit 1 can be mounted when the video display device 100 is used to visualize stereoscopic video images. When the video display device 100 is used to display normal video images (two-dimensional images), the frame unit 1 can be demounted.

<3. Exemplary structures of light emitting units>

### [Rectangular Package]

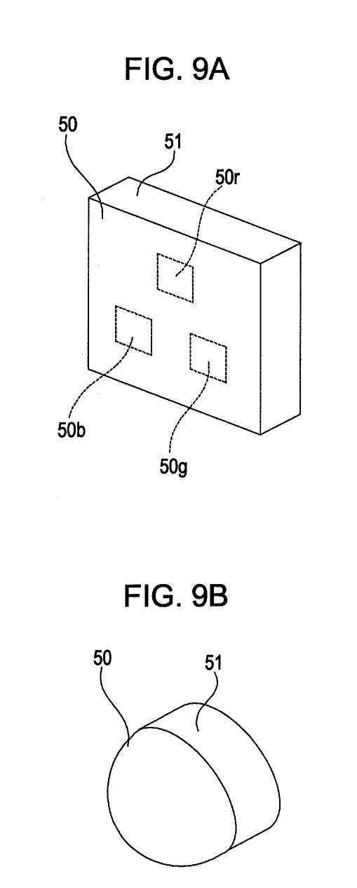

FIGS. 9A and 9B illustrate exemplary structures of light emitting units. FIG. 9A shows a light emitting unit included in a rectangular package. This light emitting unit 50 has light emitting elements sealed in a rectangular package 51. In the light emitting unit 50, a light emitting element 50r emitting red light, light emitting element 50g emitting green light, and light emitting element 50b emitting blue light are arranged in a predetermined order.

The light emitting elements, however, are not limited to the above three light emitting elements 50r, 50g, 50b; one or more light emitting elements emitting a single color may be sealed in a single package, or four or more light emitting elements may be arranged, or colors other than the above may be used.

### [Round Package]

FIG. 9B shows a light emitting unit included in a round package. This light emitting unit 50 has light emitting elements sealed in a round package 51. As with the case of the rectangular package described above, a plurality of light emitting elements emitting different colors may be sealed, or one or more light emitting elements emitting a single color may be sealed.

If the frame unit 1 according to this embodiment is applied to the light emitting units 50 included in the round packages 51, the legs 12 may be arranged so as to fit around virtual quadrangles, each of which circumscribes the round package 51. Alternatively, the frame body 11 may have round openings shaped according to the shape of the round package 51.

Examples of the light emitting elements employed in the light emitting units 50 housed in the different packages described above may include semiconductor lasers and organic EL light emitting elements, in addition to the LEDs. Polarizing plates may be built into the surfaces of the light emitting elements in the light emitting unit 50 (for example, in the surfaces of LED chips) or in the packages as appropriate. If the light emitting unit 50 having polarizing plates built therein is employed, the frame 10 may not necessarily have the polarizer 20 mounted in advance.

According to this embodiment, a video display device that does not generate polarization fluctuations can be implemented simply by fitting the frame unit 1 to the light emitting unit 50. Since at least the front surface of the frame body is colored in a color that suppresses the reflection of light, the frame body serves as the black stripes provided in the gaps between the light emitting units 50. By synergistic effects of these features, stereoscopic video images can be visualized at a higher contrast and a brightness approximately 10-20% higher than a typical video display device in the past.

The present application contains subject matter related to that disclosed in Japanese Priority Patent Application JP 2009-134787 filed in the Japan Patent Office on Jun. 4, 2009, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A frame unit for a video display device, the frame unit comprising:
a frame having a frame body and a plurality of mutually facing legs, the frame body being disposed around a light emitting unit, the legs extending from the frame body so as to be fitted along side surfaces of the light emitting unit; and
a polarizer being provided so as to extend between the mutually facing legs of the frame.

2. The frame unit according to claim 1, wherein the frame is detachably fitted around the light emitting unit.

3. The frame unit according to claim 1, wherein at least a front surface of the frame body of the frame is colored in a color that suppresses light reflection.

4. The frame unit according to claim 1, wherein at least a front surface of the frame body of the frame is surface-treated so as to suppress light reflection.

5. The frame unit according to claim 1, wherein the frame is made of a flexible material.

6. The frame unit according to claim 1, wherein the frame is fitted over a plurality of light emitting units arranged at predetermined intervals, with the legs being fitted along side surfaces of the plurality of light emitting units.

7. The frame unit according to claim 3, wherein the frame is fitted over a plurality of light emitting units arranged at predetermined intervals, with the legs being fitted along side surfaces of the plurality of light emitting units.

8. The frame unit according to claim 4, wherein the frame is fitted over a plurality of light emitting units arranged at predetermined intervals, with the legs being fitted along side surfaces of the plurality of light emitting units.

9. The frame unit according to claim 1, wherein the frame is fitted over a plurality of light emitting units arranged in rows and columns at predetermined intervals, with the legs being fitted along side surfaces of the plurality of light emitting units.

10. A video display device comprising:
a video display unit having a plurality of light emitting units arranged in rows and columns;
a frame having a frame body and a plurality of mutually facing legs, the frame body being disposed around a plurality of light emitting units of the video display unit, the legs extending from the frame body and being fitted along side surfaces of the light emitting units; and
a plurality of polarizers being provided so as to extend between the mutually facing legs of the frame.

11. The video display device according to claim 10, wherein the frame is detachably fitted into gaps between the light emitting units.

12. The video display device according to claim 10, wherein the polarizers include two types of polarizers different in polarization direction and disposed alternately in every other row of light emitting units of the video display unit.

13. A member comprising:
a frame having a frame body and a plurality of mutually facing legs, the frame body being disposed around a light emitting unit, the legs extending from the frame body so as to be fitted along side surfaces of the light emitting unit; and
a polarizer extending between the mutually facing legs of the frame so as to be supported by the mutually facing legs.

14. The member according to claim 13, wherein the frame is fitted over a plurality of light emitting units arranged in rows and columns at predetermined intervals, with the legs being fitted along side surfaces of the plurality of light emitting units.

15. A video display device, comprising:
a video display unit having a plurality of light emitting units arranged therein;
a frame having a frame body and a plurality of mutually facing legs, the frame body being disposed around a plurality of light emitting units of the video display unit, the legs extending from the frame body and being fitted along side surfaces of the light emitting units; and
a plurality of polarizers extending between the mutually facing legs of the frame so as to be supported by the mutually facing legs.

16. The video display device according to claim 15, wherein at least a front surface of the frame body of the frame is colored in a color that suppresses light reflection.

17. The video display device according to claim 15, wherein at least a front surface of the frame body of the frame is surface-treated so as to suppress light reflection.

18. A video display device comprising:
a video display unit having a plurality of light emitting units arranged therein;
a frame having a frame body and a plurality of mutually facing legs, the frame body being disposed around a plurality of light emitting units of the video display unit, the legs extending from the frame body and being fitted along side surfaces of the light emitting units; and
a plurality of polarizers extending between the mutually facing legs of the frame so as to be supported by the mutually facing legs;
wherein the polarizers include two types of polarizers different in polarization direction and alternately disposed.

19. The video display device according to claim 18, wherein at least a front surface of the frame body of the frame is colored in a color that suppresses light reflection.

20. The video display device according to claim 18, wherein at least a front surface of the frame body of the frame is surface-treated so as to suppress light reflection.
